(19) United States
(12) Patent Application Publication
(10) Pub. No.: US 2011/0287271 A1
(43) Pub. Date: Nov. 24, 2011

(54) METHOD FOR PRODUCING A COATING POWDER

(75) Inventors: Gerhard Reusmann, Essen (DE); Angela Kleinkorres, Wetter (DE)

(73) Assignee: EWALD DOERKEN AG, Herdecke (DE)

(21) Appl. No.: 13/143,469

(22) PCT Filed: Jan. 6, 2010
(86) PCT No.: PCT/EP2010/050077

§ 371 Date: Aug. 8, 2011

(30) Foreign Application Priority Data
Jan. 6, 2009 (DE) 10 2009 004 141.9

(51) Int. Cl. B32B 15/04; C08K 3/22; C09D 163/00

(52) U.S. Cl. 428/457; 523/400; 523/457

(57) ABSTRACT

A method for producing a coating powder is provided, including the steps of providing a powdery basic composition, comprising binders, and mixing at least one powdery aggregate with the powdery basic composition to produce a finished coating powder, wherein, during mixing, a powdery state of the aggregate and the basic composition is maintained, and wherein at least one lubricant is used as said powdery aggregate which does not melt as the binder cures.

### BACKGROUND OF THE INVENTION

The invention relates to a method for producing a coating powder, and a coating powder.

In the state of the art, coating powders are important for coating workpieces, in addition to lacquers containing water or organic solvents which are applied in liquid form. Coating powders are applied to the workpiece as solids in powdery form. In conventional powder coating methods, the workpiece to be coated is earthed. The powder is electrically charged (for example by means of a high-voltage electrode in the corona technique) and, after having been transported towards the workpiece by an air flow, adheres to its surface, to which it is electrostatically attracted. Subsequently, a film is formed on the workpiece. This is typically achieved by heating at least the surface of the workpiece. Either a thermoplastic binder contained in the coating powder melts and forms a coating film as it cools, or one or more binders cure under the influence of heat. Powder coating systems, curable by UV radiation, for example, can also be used.

A coating powder, in its most basic form, consists of a binder. However, coating powders usually comprise aggregates, such as pigments, additives and fillers, present in solid form, just like the binder. By these means, certain surface properties, such as color, gloss, hardness, coefficient of friction etc., can be adjusted, that the binder does not provide. Fillers, among other things, serve to “dilute” the binder component and thus to save cost. Various aggregates will be explained in more detail below.

According to the state of the art, first, the binder and the aggregates are weighed, mixed and then extruded. The raw materials are intensively homogenized by the extrusion process. This is achieved by melting the binder, accompanied by intensively acting shearing forces, optimally distributing the aggregates in the coating material. In an extruder, one or more screws are arranged in a heatable housing for mixing and dispersing the raw materials during transportation in the extrusion process. The result is a largely homogeneous mass, which forms granules as it cools down and hardens, and which is subsequently ground. In the finished coating powder, the particles of the aggregates are at least partially coated with the binder. Often, in a last process step, the separating step (e.g. in a centrifugal separator), powder particles that are too small are separated out (DE 196 44 728 A1, DE 196 07 914 A1).

However, the method according to the state of the art has drawbacks. Since the aggregates are coextruded with the binder, they can damage the interior of the extruder. If particularly hard particles are added in order, for example, to ensure hard, abrasion-resistant coatings, they cause abrasion on the extruder housing and the screws, in particular due to the great forces arising there. After long operating periods, this eventually leads to parts having to be exchanged. Certain solid lubricants serving to adjust the tribological properties of the powder coating, often tend to adhere to surfaces in the interior of the extruder and can only be removed with difficulty. Without intensive, expensive cleaning, the extruder is no longer useful.

It is therefore the object of the present invention to suggest steps to avoid damage to the production facilities in the production of a coating powder with a powdery aggregate.

### SUMMARY OF THE INVENTION

The object is achieved by a method according to the following disclosure.

A method for producing a coating powder is provided, including the steps of providing a powdery basic composition, comprising binders, and mixing at least one powdery aggregate with the powdery basic composition to produce a finished coating powder, wherein, during mixing, a powdery state of the aggregate and the basic composition is maintained, and wherein at least one lubricant is used as said powdery aggregate which does not melt as the binder cures.

### DETAILED DESCRIPTION

In the method according to the present invention for producing a coating powder, in a first step, a powdery basic composition comprising a binder, is provided. Such a basic composition is typically already a fully functional coating powder. Just as in the prior art, any substance is deemed a binder which, alone or in combination with other substances (e.g. hardeners or catalysts), is capable of forming a coating film on a surface of a workpiece. Usually, the basic composition will thus be film-forming, while it is also conceivable that an additional component is necessary. Thus, the basic composition can contain a binder, for example, which only cures when combined with a hardener, the hardener not being comprised in the basic composition, but added later.

The term powdery means that the basic composition is present as an extremely fine-grain mixture. The grain size is usually in the range typical for coating powders according to the state of the art, so that the majority of the grains have a size between 10 μm and 100 μm. While basically coarser or finer-grain powders are conceivable, they have poor handling properties in the coating process as is known to the person skilled in the art. The grains can be inherently heterogeneous or homogeneous, various grains of different composition can also be present.

According to the present invention, in a second step, at least one powdery aggregate is mixed with the powdery basic composition to produce a finished coating powder. Herein, it is possible both to add the aggregate to the basic composition prior to or during mixing and to add the basic composition to the aggregate, or to fill the two components in parallel into an apparatus or a container for mixing. Certain aggregates of particular importance in the context of the present invention will be mentioned in the following.

Solids having a small grain size will be referred to as powdery, according to the usual definition. However, it is also possible for an aggregate to contain small amounts of liquid.

According to the present invention, a powdery state of the aggregate and basic composition will be maintained. There is thus no complete fusing as in the extrusion process, which would require subsequent grinding. Neither are these method steps necessary in the further procedure. The coating powder is “finished” after mixing in the sense that it can be directly applied and further processed into a coating according to methods known from the state of the art. A certain degree of grinding of the powdery components is possible. Also, as will be explained below, partial melting can be caused. Still, the components will remain powdery during the entire mixing process. In particular, they will remain essentially unchanged in their composition.

In many cases, the method according to the present invention can be carried out without the introduction of heat. Herein, the composition of grains of the basic composition and the aggregate remains the same. This is in contrast to the extrusion process, in which the components fuse together so that, after grinding the extrusion product, practically each individual grain comprises a mixture of the individual components. Mechanical separation of the individual components is thus virtually impossible.

If the present method is carried out without heating the components, the grains of the aggregate are still separately present after mixing, or if anything, they are loose agglomerates with grains of the basic composition. The term “separate” in the present case must be interpreted as meaning that individual grains are not bonded to each other. The distribution of the grains within the coating powder is, of course, random due to the mixing process, and macroscopic separating of the aggregate and the basic composition is, of course, impossible.

In agglomerates, individual grains loosely adhere to each other, e.g. due to electrostatic interaction. In this case, however, microscopic examination shows that a plurality of small grains is present, which adhere to each other in point-wise rather than in flat surface contact. This must be held distinct from aggregates which are formed during extrusion. In the latter case, the individual components of a grain (e.g. binder, filler, pigments etc.) while chemically separate, are bonded to each other in surface contact due to the effect of forces and heat.

If there is no heating, the grain sizes of the basic composition and the aggregate will typically remain the same upon mixing in the present method. Again, this is in contrast, for example, to the extrusion method, where agglomerates of the aggregates are broken up and their grain sizes are thus changed. In the mixing process according to the present invention, there is usually no grinding or the like, with the attendant pressures and shearing forces required for it.

The statement with respect to the grain sizes must be understood as a statistic statement. On the one hand, the grain sizes of both the basic composition and the aggregate are usually non-uniform, but statistically distributed. The fact that the grain sizes remain the same thus means that the above statistical distribution remains the same. Moreover, it is understood that, in each mixing process, a small proportion (e.g. 5% or less) of the grains, of which the powders consist, can be broken apart. The small change of the grain size distribution caused thereby, is neglected in the present case, when it is stated that the grain sizes remain the same. Such breaking apart only happens inadvertently in the present method and must be distinguished from methods according to the prior art, in which a considerable proportion of the grains (e.g. 50-95%) is broken apart.

In addition, there may be loose agglomerates—also among the grains of the basic composition or the aggregate—i.e. smaller grains may adhere to each other and may thus form a large grain. Such agglomeration, which can also come about without any introduction of heat, may slightly change the grain size distribution.

Since high temperatures, pressures and shearing forces are largely avoided with the method according to the present invention, the wear and tear of an apparatus used for mixing the components (referred to as a “mixer” in the following) is minimized, just like soiling of the apparatus. This will be explained in the following with reference to aggregates that are preferably used in the present method.

It has also been shown that for certain aggregates used for adjusting the surface properties, extrusion can be disadvantageous because the surfaces of the individual grains of the aggregate are entirely or largely fused together and covered with binder. This can have a negative effect in the finished coating, since the grains in question, even when they are at the surface of the cured coating film, are always covered with binder, which reduces their influence on the adjustment of surface properties, such as the coefficient of friction.

In coating powders produced with the method according to the invention, intensive fusing together with the binder, or bonding to the matrix of the cured binder, only happens during the coating process. During mixing, there may be only slight superficial melting, which can lead to individual grains adhering to each other. For this reason, grains of aggregates are not normally covered or only partially covered with binder in the area of the surface of the coating film, and essentially protrude from the coating film, with the result that they can be optimally used for adjusting surface properties.

Apart from this, there are other advantages. The method according to the invention is highly flexible with respect to the provision of specially refined coating powders, in particular in small quantities. A larger amount of the basic composition can thus be produced and stored at the factory. According to the customer's specification, smaller amounts of coating powder can be produced on a short-term basis, each containing precisely the aggregates required for each specific application. Providing smaller amounts of specially refined coating powder is not possible, or rather, not economical, with the method according to the prior art.

It is also possible to have the basic composition produced by a first manufacturer, but to have the mixing with the aggregate performed by a second manufacturer. In this case, the second manufacturer does not even need expensive equipment for extrusion, grinding and separating of the basic composition. On the other hand, the facilities for producing the basic composition can work much more economically and without unnecessary standstill since adjustment for other compositions is required less frequently.

Mixing can be implemented in various ways. A preferred method is stirring. Herein, the aggregate and the basic composition (in the following the two components will be commonly referred to as “powder”) are in a container (e.g. in a trough) and are mixed by a moving stirring tool. The stirring tool, which can have a paddle- or hook-like configuration, for example, moves relative to the components to be mixed. Various movements of the stirring tool are conceivable, in particular rotary and oscillating (i.e. reciprocating) movements.

Even if no stirring tools are present, mixing can be achieved by means of shaking the powder. If the receptacle containing the powder performs shaking, i.e. oscillating, movements, this results in the basic composition and the aggregate becoming mixed due to the inertia of the powder. The shaking movement can have both vertical and horizontal components.

Furthermore, the components can be mechanically stirred to achieve mixing. This variant is characterized by a combination of mechanical forces and gravitational pull and centrifugal force, as the case may be. Due to the alternating influence of the above forces, the powder moves in a circuit, i.e. it is first lifted up, for example, and then falls back down under the influence of the force of gravity. Mixing of the powder can be achieved, for example, by rotating a container about an axis of rotation not aligned with the direction of gravitational pull, in particular if protrusions, hooks or the like are integrated in the side wall of the container, by which the powder is “engaged”, that is lifted. After the powder has been lifted up to a certain height, it falls back down, is lifted again, etc. Herein, it is also conceivable for part of the movement cycle to be carried out under the influence of centrifugal force. In a rotating container the following sequence of movements is thus conceivable: migration along the bottom to the side—mechanical transport upwards and inwards—falling down under the influence of gravity—migration to the side, etc.

Mixing can also be achieved by the effect of sound. Herein, sonic waves can be transmitted to the powder through the air or, for example, through a container side wall. Thereby the powder is mixed at a suitable frequency, which can be easily determined by means of scanning through.

A further variant of the method is swirling the powder. Herein, the powder is moved by an air flow generated by a fan or the like. Since the ratio of the weight to the friction of air is about proportional to the longitudinal extension of a particle, the very small particles of the basic composition and the aggregate—also at increased density—are easily carried along by the air flow. In this variant of the method, it is advantageous to carry out mixing in a largely closed container and to make any necessary openings (e.g. for the introduction of the air flow) impermeable to particles by means of filters.

To improve bonding of aggregates to the binder the method can be varied by heating the basic composition and/or the aggregate prior to, during and/or after mixing, and thus at least part of the grains of the aggregate material are at least partially fused together with the grains of the basic composition. However, also in this variant, a powdery state of the aggregate and the basic composition is maintained during mixing and heating, i.e. there is no large-scale fusing of a large number of grains, which would necessitate subsequent grinding. Rather, there is a slight fusion effect. This can be advantageously implemented, for example, by heating the aggregate material immediately prior to mixing, whereby grains of the basic composition superficially melt and lightly adhere on contact. As an alternative, the aggregate can be heated during or after mixing by means of electromagnetic waves, the frequency of which is chosen such that there is essentially no direct heating of the basic composition. Primary heating of the aggregate can avoid further fusion of grains of the basic composition with each other.

The method of the present invention is particularly suitable for cases in which at least one aggregate material comprises a lubricant. The addition of lubricants is advantageous if a workpiece is to be coated which is frequently exposed to friction in use, such as hinged portions, belt deflectors, lock parts etc. On the one hand, user-friendly, smooth functioning of the part in question is achieved, on the other hand, the mechanical stresses on the coating are reduced since the shearing forces which build up are markedly reduced. As already initially described, lubricants can soil the extruder according to the prior art. If an aggregate material comprising a lubricant is, however, mixed with the basic composition in a powdery state, there is hardly any deposition of lubricants on the surfaces of the apparatus used for mixing due to the absence of larger shearing forces, pressure or higher temperatures. Intensive cleaning of the apparatus is thus not or not frequently necessary.

It is explicitly not excluded that the basic composition comprises substances which are used as lubricants in the prior art. However, in the method according to the present invention of the basic composition they are not normally used as lubricants for the adjustment of tribological properties of the finished coating, but as processing agents, e.g. to support an extrusion process.

All substances known from the state of the art can be used as lubricants, e.g. halogen hydrocarbons, in particular polytetrafluoroethylene (PTFE), polyvinylidene fluoride (PVDF), tetrafluoroethylene/hexafluoropropylene copolymer (FEP), perfluoroalkoxy copolymer (PFA), copolymer of tetrafluoroethylene with perfluorinated propylene and perfluoroalkyl vinyl ether (EPE), copolymer of tetrafluoroethylene and perfluoromethyl vinyl ether (MFA), MoS₂, boron nitride, graphite, fluorinated graphite, polysulfones, mixtures of the above or a combination thereof. These lubricants can be added as powdery aggregates and do not melt as the coating powder softens, flows and cures. They will be referred to as melt-resistant lubricants in the context of the present invention.

The method according to the invention is also very advantageous for very hard aggregates, so-called hard materials. This relates to aggregates, in particular, comprising particles having a hardness of at least 5, preferably at least 7, particularly preferably at least 9, on the Mohs hardness scale. Such particles are used, in particular, where a coating is exposed to intense mechanical stresses. Embedding very hard particles, often partially protruding from the surface of the coating, protects the entire coating against pressure and shearing forces, and thus prevents abrasion. Advantageously such particles can be used in combination with lubricants.

However, since the dispersion of such hard particles in an extruder is associated with extreme shearing forces, the hardness of the particles is extremely conducive to wear and tear in the extruder. In the method according to the invention, there are no increased pressures or significant shearing forces, which is why the apparatus used for mixing is hardly liable to be damaged by such hard particles. Preferred particles, which are characterized by great hardness, are silicic acid, aluminum oxide or silicon carbide particles, nitride compounds, such as boron nitride, silicon or titanium nitride, and microglass hollow spheres.

The basic composition in the method according to the invention, as in the prior art, is preferably provided by means of co-extruding a plurality of components. Such extrusion is typically followed by cooling, breaking (e.g. granulating) and grinding of the extrudate. This can then be followed by separating the powder thus provided in order to separate out particles of an unsuitable size.

Basically all substances can be used as binders for the basic composition that are also used in coating powders according to the state of the art. These are, for example, binders that are thermally or UV curable, such as epoxy resins, polyester, acrylate resins, methacrylate resins and polyurethanes. Thermoplastic materials, in particular polyamide, polyolefines (in particular homo- or copolymers of ethene, propene, butene), polyvinylchloride and polyvinylidene chloride, can also be used. It is also explicitly suggested to use mixtures of binders. For this purpose, thermally or UV curable binders can also be combined with thermoplastic materials.

In many cases, a coating powder for coating a metallic workpiece is to be produced by the method according to the present invention. Metallic workpieces are exposed to a greater or lower risk of corrosion, depending on the type of metal and the location of use. One option for providing effective corrosion protection is the inclusion of metal particles in the coating. For this reason, at least one aggregate and/or the basic composition can comprise metal particles in an embodiment of the invention. The use of metal particles in the basic composition is known from the prior art and is unproblematic in an extrusion process. However, later mixing of the basic composition and metal particles contributes to the flexibility of the method, since coating powders with the desired metal particle content can be quickly provided with rather little effort.

The metal particles used can be of various kinds. Preferably, the material of the metal particles is chosen from the group comprising zinc, aluminum, tin, magnesium, nickel, cobalt, manganese, titanium or alloys of the same. Mixtures of metal particles of different compositions can also be used. The particles can be provided in the form of flakes, lamellae, grains, dust or a combination thereof. Preferably, metal particles of different chemical composition, e.g. zinc and aluminum particles, can also be used.

The metal particles can also be surface-treated. Typical surface treatments according to the state of the art are, for example, by means of coating with various salts, such as oxides of aluminum, titanium, zirconium, chromium, nickel or silicon, salts of rare earths, organic or inorganic polymers, fatty acids, such as stearic acid or oleic acid. Phosphating or prior oxidation of the surface of the metal pigments, as it is used to adjust a certain color according to the state of the art, is also included in the meaning of surface treatment.

Other additional components, which the basic composition can comprise, are cross-linking agents and additives, such as flow-control agents, degassing agents and structural agents. In addition, pigments and colorants are also considered. The former can serve for visual designing, wherein inorganic pigments (e.g. titanium oxide, iron oxides, chromium dioxide etc.) are used as well as organic pigments (e.g. carbon black, azo pigments etc.) and effect pigments to generate metallic or pearl gloss effects. Certain pigments can also be used for corrosion protection, such as certain phosphates, alkali silicates or salts of rare earths. In addition, the basic composition can also comprise fillers, such as calcium carbonates, talcum or barium sulfate. A combination of the above components is of course also possible.

The coating powder produced by means of the method according to the invention is useful for coating various workpieces by means of coating methods known from the state of the art, such as electrostatic powder spraying or whirl sintering. The coating powder is particularly suitable for attachments used in the automotive industry, such as belt deflectors, handles, levers, parts of seats, parts of locks, hinged parts etc.

Particularly preferably the coating powder is applied to a metallic workpiece provided with a zinc-containing corrosion protection layer. Such an anticorrosive layer can be applied by means of hot-dip zinc coating or electroplating. In combination with the coating powder produced according to the present invention a workpiece results that is particularly resistant against corrosion and mechanical stresses.

Details of the invention will be explained in the following with reference to exemplary embodiments.

### Example 1

The following components are provided to produce a basic composition of a coating powder.

| | |
|---|---|
| Araldite GT 7203 (epoxy resin) | 71.00 wt. % |
| Aradur 3082 (phenolic hardener) | 26.40 wt. % |
| Byk 360P (anti-crater and flow-control additive) | 1.40 wt. % |
| Lanco TF 1778 (PTFE/PE wax, processing agent) | 0.20 wt. % |
| carbon black FW 200 pearled | 1.00 wt. % |

The components were weighed individually and filled into a special container having the form of a reversed cone with an open base. A container mixer (made by: MIXACO) is used for the mixing process. This mixer comprises a dual base mixing plant, under which the container with the material to be mixed is moved. In this state, the open base of the cone faces upward. A matching counterpart, which is part of the mixer, is locked onto the container. Then the container is swiveled by 180° into the mixing position so that the tip of the cone points upwards. The material to be mixed is moved upwards and inwards by a rotating mixing tool having the form of a tapering spiral, matching the shape of the container, until, in the area of the tip of the cone, it falls back down to the bottom through the hollow center of the mixing tool. Once at the bottom, the material to be mixed is moved outwards and subsequently upwards again by the mixing tool as described. This mixing cycle is particularly gentle to the material, and there are no noticeable mechanical pressures or shearing forces.

The components are mixed for 5 minutes, until they are homogeneous. After the mixing process, the apparatus is swiveled back by 180° and the container is released.

The homogenized mixture is melted and dispersed in a co-kneader (made by Buss) under the effect of heat and mechanical pressure. The small amount of PTFE/PE wax contained in the basic composition does not lead to any noticeable soiling of the extruder. The mass extruded in this way is hardened in a compact cooler and subsequently roughly broken up. This is followed by processing in a rotor-separator mill, wherein the material is ground and separated to grain sizes in the range of up to 80 μm. Particles that are too small are subsequently separated out in a centrifugal separator.

The basic composition produced in this manner is a coating powder in its own right that is ready for use.

In a second section of the method, the coating powder is subsequently refined by adding powdery aggregates. On the one hand the abrasion resistance, and on the other the tribological properties of the coating made from the coating powder are to be optimized. For this purpose, an aluminum oxide having a hardness of 9 on the Mohs hardness scale, and molybdenum sulfide as a solid lubricant, are added.

The weight percentages are as follows:

| | |
|---|---|
| Basic composition | 81.30 wt. % |
| Alodur ZWSK- AT F 1000 (aluminum oxide) | 16.30 wt. % |
| Molybdenum sulfide OKS 110 | 2.40 wt. % |

The above components are mixed again for 5 minutes in a container mixer. This achieves sufficient homogenization. The mixing process is carried out at room temperature, and—as already explained—is particularly gentle to the materials, since no noticeable pressures or shearing forces act on the powder particles. For this reason, the interior of the mixer is neither damaged by the extremely hard aluminum oxide particles, nor is it soiled by molybdenum sulfide, which could deposit on the surfaces in the interior of the mixer. The grain size of the individual components does not vary. Also, there is no agglomeration of the components; after mixing with the aggregates, the result is a finished coating powder that can still be used.

The coating powder is now ready for use and can be filled into suitable containers. It can be applied by means of the usual coating methods for powder coatings and can cure to a coating. Coatings produced with the recipe described above are characterized by excellent abrasion resistance and low surface friction. In numerous applications, e.g. in hinged parts, lubrication with grease or liquid lubricants can be dispensed with because of the corresponding coating.

### Example 2

To optimize the tribological properties of a coating for a new part, various lubricant aggregates are to be tested. For this purpose, a container of 100 kg of the basic composition of example 1 is purchased. Now, in a laboratory mixer (standard vertical mixer) 2 kg portions of the basic composition are mixed with respective different lubricant aggregates. 50 different test compositions are thus produced. 10 of the compositions contain polytetrafluoroethylene (s_{d} value 7 μm) or molybdenum sulfide (s_{d} value 4 μm) or boron nitride (s_{d} value 5 μm) or graphite (s_{d} value 12 μm), or polyvinylidene fluoride (PVDF) (s_{d} value 8 μm), wherein the proportion within the respective 10 compositions is increased in steps of 5 g to a final value of 50 g. The average diameter of the lubricant particles is thus between 4 μm and 12 μm.

A group of parts is coated with each of the test compositions produced in this manner using an electrostatic powder spraying method. Subsequently, the properties of the individual coatings can be examined.

Providing small amounts of specially refined coating powder as in the example shown is hardly possible with methods according to the prior art.

### Example 3

In analogy to the method according to example 1, a powdery basic composition is produced by means of co-extrusion, grinding and separating, having the following ingredients:

| | | |
|---|---|---|
| D.E.R. 662 (epoxy resin) | 13.00 | wt. % |
| Epikote 1055 (epoxy resin) | 4.2 | wt. % |
| Epikote 1007 (epoxy resin) | 26.0 | wt. % |
| Lamp black | 1.0 | wt. % |
| Minex (silicate filler) | 54.0 | wt. % |
| 2-methylimidazolium (promoter) | 1.0 | wt. % |
| BYK 360 P (flow-control agent) | 0.8 | wt. % |

For a customer order of limited quantity, 50 kg of a coating powder is to be produced for a particularly hard-wearing coating. For this purpose, 85 weight percent of the basic composition are mixed with 15 weight percent silicon carbide powder (s_{d} value 5 μm) in a standard vertical mixer.

The thus produced coating powder can be applied using an electrostatic powder spraying method and cured at 150° C. The coating is particularly resistant to abrasion due to the embedded silicon carbide particles having a hardness of 9.6 on the Mohs hardness scale.

1-13. (canceled)

14. A method for producing a coating powder, comprising the steps of
providing a powdery basic composition, comprising binders, and
mixing at least one powdery aggregate with the powdery basic composition to produce a finished coating powder,
wherein, during mixing, a powdery state of the aggregate and the basic composition is maintained, and wherein at least one lubricant is used as said powdery aggregate, which does not melt as the binder cures.

15. The method according to claim 14, wherein said mixing is carried out by means of stirring, shaking, mechanical blending, the effect of sonic waves or whirling.

16. The method according to claim 14, wherein at least part of the grains of the aggregate are at least partially fused together with grains of the basic composition by means of heating the basic composition and/or the aggregate prior to, during and/or after mixing.

17. The method according to claim 14, wherein a lubricant is used, which is chosen from the group consisting of halogen hydrocarbons, MoS₂, boron nitride, graphite, fluorinated graphite, polysulfones, and mixtures thereof.

18. The method according to claim 14, wherein the lubricant is selected from the group consisting of polytetrafluoroethylene (PTFE), polyvinylidene fluoride (PVDF), tetrafluoroethylene/hexafluoropropylene copolymer (FEP), perfluoroalkoxy copolymer (PFA), copolymer of tetrafluoroethylene with perfluorinated propylene and perfluoroalkyl vinyl ether (EPE), copolymer of tetrafluoroethylene, perfluoromethyl vinyl ether (MFA) and mixtures thereof.

19. The method according to claim 14, wherein the basic composition is provided by means of co-extruding a plurality of components.

20. The method according to claim 14, wherein the binder is selected from the group consisting of epoxy resins, polyesters, acrylate resins, methacrylate resins, polyurethanes and thermoplastic materials, and mixtures thereof.

21. The method according to claim 14, wherein the binder is selected from the group consisting of polyamide, polyolefines, polyvinylchloride and polyvinylidene chloride, and mixtures thereof.

22. The method according to claim 14, wherein at least one aggregate comprising metal particles and/or a basic composition comprising metal particles is used.

23. The method according to claim 22, wherein metallic particles are used, which are selected from the group consisting of zinc, aluminum, tin, magnesium, nickel, cobalt, manganese, titanium, and mixtures and alloys thereof, in the form of flakes, lamellae, grains, dust, and combinations thereof.

24. A coating powder, produced according to a method according to claim 14.

25. Use of a coating powder according to claim 24 for coating workpieces.

26. Use according to claim 25, wherein the workpiece is a metallic workpiece having a zinc-containing corrosion-protection coating.

27. Use according to claim 25, wherein the workpieces are particular attachments used in the automotive industry.
